(19) United States
(12) Patent Application Publication
(10) Pub. No.: US 2007/0215734 A1
(43) Pub. Date: Sep. 20, 2007

(54) Blade axle assembly for a shredder

(75) Inventor: Tony Tsai, Shanghai (CN)

Correspondence Address: COOPER & DUNHAM, LLP, 1185 AVENUE OF THE AMERICAS, NEW YORK, NY, 10036, US

(73) Assignee: Shanghai Juhsin Electronics Co., Ltd.

(21) Appl. No.: 11/375,299

(22) Filed: Mar. 14, 2006

(51) Int. Cl. B02C 18/18

(52) U.S. Cl. 241/236

(57) ABSTRACT

A blade axle assembly for a shredder includes two parallel blade axles. Each of the blade axles has an elongated slots axially defined at an outer periphery of the blade axle. A spacing bar is mounted in the elongated slot. The spacing bar is alternatively formed with multiple teeth and recesses. Multiple blade units are mounted on the blade axles. Each of blade units has two blades. The blade has a central hole defined through the blade, and positioned in a corresponding recess of the spacing bar. The teeth and recesses of the two blade axles are staggered, so the blade units on the two blade axles are alternately arranged. Whereby, it is convenient to install the blade units. Moreover, a reinforcing bracket is mounted on the blade axles to improve its rigidity, so the blade axles will not be pressed outwards and can effectively shred paper.

### BACKGROUND OF THE INVENTION

1. Field of the Invention

The present invention relates to a blade axle assembly, and more particularly to a blade axle for a paper shredder.

2. Description of Related Art

A shredder is a common machine to shredding waste or outdated confidential documents or files. Because the shredder is used easily and safely, it has become a required office appliance.

A conventional paper shredder generally includes two parallel blade axles mounted in a shredder head. Multiple blades are provided on each of the blade axles. The blade axles each have a polygonal cross section, and the blades each have a central opening with a polygonal cross section corresponding to the blade axle. Thus, the blades can be rotated along with the respective blade axles. A spacer with an outer diameter smaller than an outer diameter of the blade is provided between two adjacent blades to define a gap in which an opposite blade on the other blade axle is located. Therefore, the blades of the two blade axles are alternately arranged. A piece of paper will be shredded by these interleaved blades when it passes through the shredder head.

For effectively shredding paper, the blade axles should be close to each other enough to locate the opposite blade into the gap between the two adjacent blades on the other blade axle. However, if the distance between the blade axles is too small, the knifepoint of the opposite blade may touch the spacer during operation and paper will be blocked. If the distance between the blade axles is too large, paper may be shredded incompletely. Thus, it is very important to correctly adjust the distance between the blade axles, but it is also very inconvenient to do it.

Furthermore, when a large amount of paper is fed into the shredder, the blade axles will be deformed outwards under the pressure of these paper and the distance between the blade axles is increased, paper will not be shredded completely yet.

Therefore, the invention provides a blade axle assembly to mitigate or obviate the aforementioned problems.

### SUMMARY OF THE INVENTION

The main objective of the present invention is to provide a blade axle assembly for a shredder which can be conveniently assembled and has a low cost.

Another objective of the present invention is to provide a blade axle assembly which has a rigidity to prevent two blade axles from being deformed outwards for retaining a distance between the two blade axles.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a blade axle assembly for a shredder in accordance with the present invention;

FIG. 2 is a perspective view of a blade axle of the blade axle assembly in FIG. 1;

FIG. 3 is a perspective view of a spacing bar of the blade axle assembly in FIG. 1;

FIG. 4 is a perspective view of a blade of the blade axle assembly in FIG. 1;

FIG. 5 is a perspective view of a reinforcing bracket of the blade axle assembly in FIG. 1;

FIG. 6 is a perspective view of a second embodiment of a blade axle assembly in accordance with the present invention;

FIG. 7 is a perspective view of a blade of the blade axle assembly in FIG. 6; and FIG. 8 is a perspective view of another blade of the blade axle assembly in FIG. 6.

### DETAILED DESCRIPTION OF THE PREFERRED EMBODIMENT

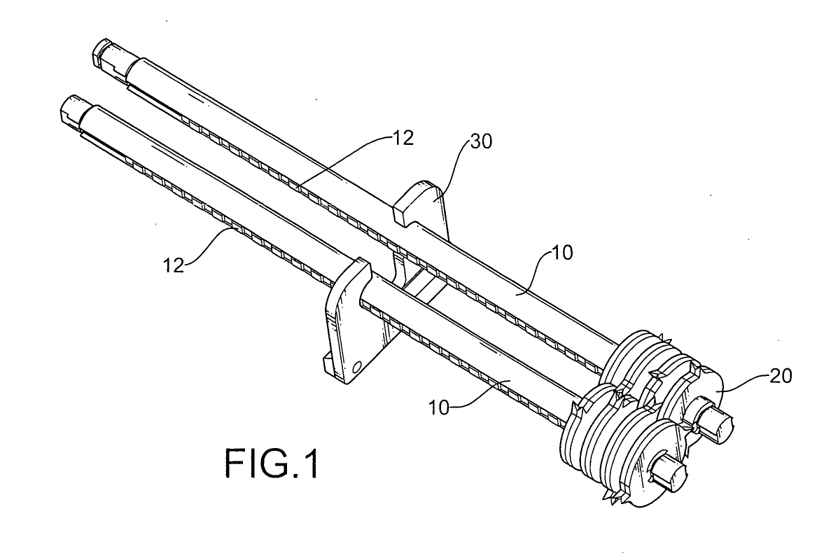

With reference to FIG. 1, a first embodiment of a blade axle assembly for a shredder in accordance with the present invention has two parallel blade axles (10) rotatably mounted on a shredder head and arranged abreast at an interval. Each of blade axles (10) has multiple blade units (20) mounted on the blade axle (10).

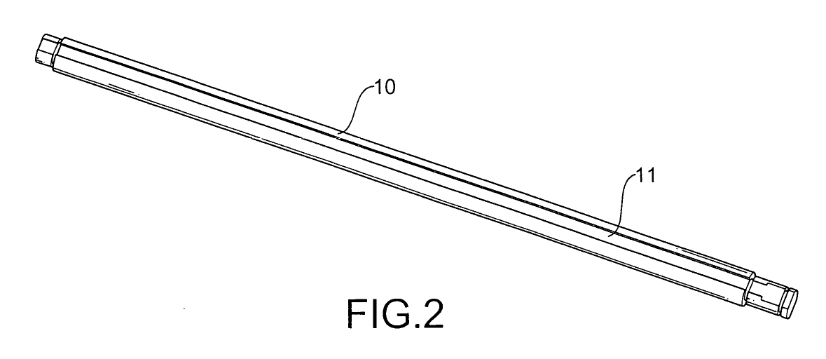

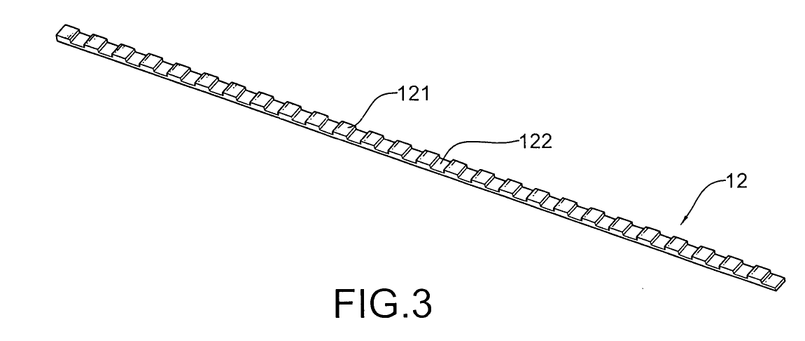

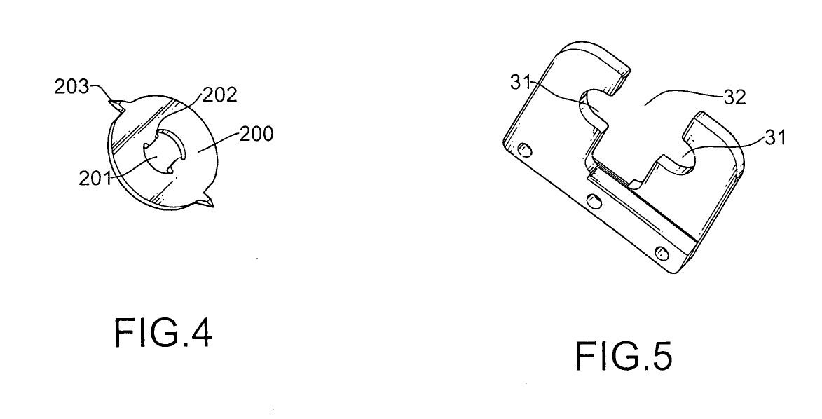

With reference to FIGS. 1-4, the blade axle (10) has a substantial circular cross section and an elongated slots (11) is axially defined at an outer periphery of the blade axle (10). A spacing bar (12) is mounted in the elongated slot (11) and has multiple teeth (121) and recesses (122) alternately defined on the spacing bar (12). The teeth (121) and recesses (122) of the two blade axles (10) are staggered. Namely, positions on one of the blade axles (10) that the teeth (121) are formed are corresponding to and are aligned with positions on the other blade axle (10) that the recesses (122) are defined, vice versa.

Each of the blade units (20) has two blades (200). Each of the blades (200) has a central hole (201) defined the blade (200). At least one lug (202) is formed in the central hole. When the blade (200) is mounted on the blade axle (10), the lug (202) is engaged in the corresponding recess (122) so as to position the blade (200) on the blade axle (10). Two cutting tips (203) are respectively formed at two oppositely diametrical sides of an outer circumference of the blade (200).

Because the teeth (121) and recesses (122) of the blade axles (10) are staggered, the blade units (20) on the two blade axles (10) are alternately arranged, as shown in FIG. 1.

In another preferable embodiment, the blade axle (10) has two opposite elongated slots (11) defined at the outer periphery of the blade axle (10), and two spacing bars (12) are respectively mounted in the elongated slots (11). The blade (200) has two lugs (202) formed at two oppositely diametrical sides of the central hole (201) and engaged in the corresponding recesses (122), so the blade (200) is securely positioned on the blade axle (10).

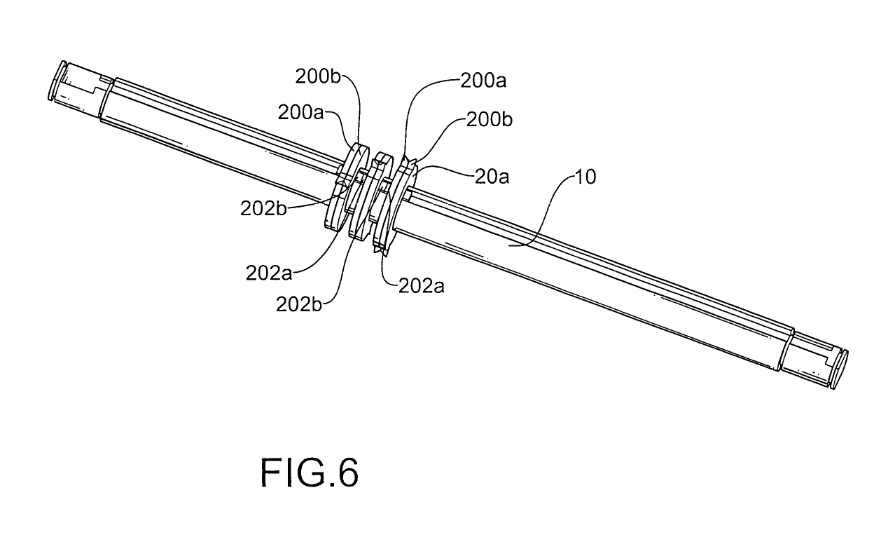

With reference to FIGS. 6-8, in a second embodiment of the blade axle assembly in accordance with the present invention, the blade axle assembly has blade units (20a) directly mounted on the blade axle (10) without the spacing bar (12). The blade units (20a) has two blades (200a, 200b) symmetrically configured. Each of the blades (200a, 200b) has at least one lug (202a, 202b) formed in the central hole (201) and protruding outwards from a side wall. The lugs (202a, 202b) of adjacent blade units (20a) are located in the elongated slot (11) and abut against each other to define gaps between the adjacent blade units (20a). Therefore, the spacing bar (12) for separating the adjacent blade units is eliminated.

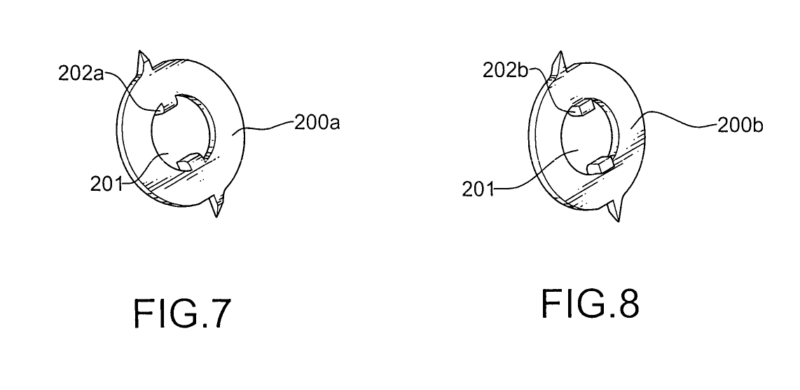

Preferably, each blade (200a, 200b) has two lugs (202a, 202b) formed at two diametrically opposite sides of the central hole (201) and respectively located in two elongated slots (11), as illustrated in FIGS. 7 and 8.

In addition, the blade axle assembly further includes a reinforcing bracket (30) installed at a middle portion of the blade axles (10) to increase their rigidity.

With reference to FIGS. 1 and 5, the reinforcing bracket (30) is formed with a U-like shape and has two curved notches (31) defined the reinforcing bracket (30). An opening (32) is defined at an upper side of the reinforcing bracket (30). The blade axles (10) are respectively positioned in the curved notches (31). When a large amount of paper passes through the blades (20), the blade axles (10) are retained by the reinforcing bracket (30) and will not be deformed outwards. Thus, the paper is shredded completely.

According to the present invention, the shredder has the following advantages:

1. The blade axle assembly is provided with the spacing bars instead of the spacers in the conventional product, so assembling the blades with the blade axles is convenient.

2. Because the teeth of the spacing bars have smaller sizes than teeth that the conventional spacers have, the cutting tips of each blade can be lengthened so as to shred more paper in one time.

3. The blade axle assembly of the present invention has a low cost because manufacturing the spacing bar only consumes less material than those for manufacturing the conventional spacers.

4. The reinforcing bracket is provided on the blade axles, so the blade axles have an improved rigidity and will not be pressed outwards even a large amount of paper passes though the blade axle assembly. Therefore, the paper is effectively shredded.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A blade axle assembly for a shredder comprising two parallel blade axles (10) arranged abreast at an interval and adapted for being mounted rotatably on a shredder head, each of the blade axles (10) having
at least one elongated slot (11) axially defined at an outer periphery of the blade axle (10);
at least one spacing bar (12) mounted in the at least one elongated slot (11) and each having multiple teeth (121) and recesses (122) alternately defined on the at least one spacing bar (12); and
multiple blade units (20) mounted on the blade axle (10), and each blade unit (20) having at least one blade (200), wherein each one of the at least one blade (200) has a central hole (201) defined through the blade (200), and at least one lug (202) formed in the central hole (201) and engaged in a corresponding recess (122) of the at least one spacing bar (12).

2. The blade axle assembly as claimed in claim 1 further comprising a reinforcing bracket (30) mounted on the blade axles (10), wherein the reinforcing bracket (30) has two curved notches (31) defined the reinforcing bracket (30) and an opening (32) defined at an upper side of the reinforcing bracket (30) and the blade axles (10) respectively extend through the curved notches (31).

3. The blade axle assembly as claimed in claim 1, wherein the teeth (121) and recesses (122) on the spacing bars (12) mounted on the two blade axles (10) are staggered, and the blade units (20) on the two blade axles (10) are alternately arranged.

4. The blade axle assembly as claimed in claim 1, wherein each of the blade axles (10) has a substantial circular cross section.

5. The blade axle assembly as claimed in claim 1, wherein each blade unit (20) has two blades (200).

6. The blade axle assembly as claimed in claim 1, wherein each of the blade axles (10) has two opposite elongated slots (11) defined at the outer periphery of the blade axle (10), and two spacing bars (12) respectively mounted in the elongated slots (11); and each of the blades (200) has two lugs (202) formed at two oppositely diametrical sides of the central hole (201).

7. The blade axle assembly as claimed in claim 2, wherein the teeth (121) and recesses (122) of the spacing bars (12) mounted on the two blade axles (10) are staggered, and the blade units (20) on the two blade axles (10) are alternately arranged.

8. The blade axle assembly as claimed in claim 2, wherein each the blade axle (10) has a substantial circular cross section.

9. The blade axle assembly as claimed in claim 2, wherein each blade unit (20) has two blades (200).

10. The blade axle assembly as claimed in claim 2, wherein:
each of the blade axles (10) has two opposite elongated slots (11) defined at the outer periphery of the blade axle (10), and two spacing bars (12) respectively mounted in the elongated slots (11); and
each of the blades (200) on each blade axle has two lugs (202) formed at two oppositely diametrical sides of the central hole (201).

11. A blade axle assembly for a shredder comprising two parallel blade axles (10) arranged abreast at an interval, each of the blade axles (10) having
at least one elongated slot (11) axially defined at an outer periphery of the blade axle (10); and
multiple blade units (20a) mounted on the blade axle (10), and each blade units (20a) having two blades (200a, 200b) symmetrically configured, wherein each of the blades (200a, 200b) has a central hole (201) defined through the blade (200a, 200b), and at least one lug (202a, 202b) formed in the central hole (201) and protruding from a side wall of the blade and located in the at least one elongated slot (11), the lugs (202a, 202b) of adjacent blade units (20a) abutting against each other to define gaps between the adjacent blade units (20a).

12. The blade axle assembly as claimed in claim 11 further comprising a reinforcing bracket (30) mounted on the blade axles (10), wherein the reinforcing bracket (30) has two curved notches (31) defined through the reinforcing bracket (30) and an opening (32) defined at an upper side of the reinforcing bracket (30); and the blade axles (10) respectively extend through the curved notches (31).

13. The blade axle assembly as claimed in claim 11, wherein the blade units (20) on the two blade axles (10) are alternately arranged.

14. The blade axle assembly as claimed in claim 11, wherein each of the blade axles (10) has two opposite elongated slots (11) defined at the outer periphery of the blade axle (10), and each of the blades (200a) of each blade axle (10) has two lugs formed at two oppositely diametrical sides of the central hole (201), and respectively mounted in the elongated slots (11).
